(19) United States
(12) Patent Application Publication
(10) Pub. No.: US 2010/0293460 A1
(43) Pub. Date: Nov. 18, 2010

(54) TEXT SELECTION METHOD AND SYSTEM BASED ON GESTURES

(76) Inventor: Joe G. Budelli, Gilroy, CA (US)

Correspondence Address: HAHN AND MOODLEY, LLP, 3333 Bowers Avenue, Suite 130, Santa Clara, CA, 95054, US

(21) Appl. No.: 12/466,333

(22) Filed: May 14, 2009

(51) Int. Cl. G06F 3/01; G06F 3/048

(52) U.S. Cl. 715/702; 715/769

(57) ABSTRACT

Tapping gestures for selecting text on a device having a touch-sensitive screen are disclosed. A single tap gesture causes a portion of a character string to be selected. A double tap gesture causes the entire character string to be selected. A tap and hold gesture causes the device to enter a cursor mode wherein the placement of a cursor relative to the characters in the character string can be adjusted. In text selection mode, a finger can be used to move the cursor from a cursor start position to a cursor end position to select text therebetween.

### FIELD

Embodiments of the present invention relate to user interfaces and systems that use finger tapping gestures.

### BACKGROUND

There currently exist various types of input devices for performing operations on electronic devices such as mobile phones, scanners, personal computers (PCs,) etc.

The operations, for example, may include moving a cursor and making selections on a display screen, paging, scrolling, panning, zooming, etc.

The input devices may include, for example, buttons, switches, keyboards, mice, trackballs, pointing sticks, joy sticks, touch surfaces (including touch pads and touch screens), etc.

Recently, the integration of touch screens on electronic devices has provided tremendous flexibility for developers to emulate a wide range of functions (including the displaying of information) that can be activated by touching the screen. This is specifically evident when dealing with small-form electronic devices (such as mobile phones, personal data assistants, netbooks, portable media players, etc.) and large electronic device embedded with a small touch panel (such as multi-function printer/copiers and digital scanners).

Existing emulation techniques based on gestures are not effective with activities/operations such as text selection and capture. Thus, it is difficult to manipulate text-based information shown on a screen using gestures. For example, operations such as selecting a correct letter, word, line, or sentence to be deleted, copied, inserted, or replaced often proves very difficult if not impossible using gestures.

### SUMMARY OF THE INVENTION

Embodiments of the invention disclose tapping gestures for selecting text on a device having a touch-sensitive screen are disclosed. A single tap gesture causes a portion of a character string to be selected. A double tap gesture causes the entire character string to be selected. A tap and hold gesture causes the device to enter a cursor mode wherein the placement of a cursor relative to the characters in the character string can be adjusted. In text selection mode, a finger can be used to move the cursor from a cursor start position to a cursor end position to select text therebetween.

Embodiments of the invention also disclose an electronic device with a touch-sensitive screen on which the tapping gestures may be used.

Other embodiments of the invention will be apparent from the detailed description below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a “single tap” gesture to select a word of text, in accordance with one embodiment of the invention.

FIG. 2 illustrates a “double tap” gesture to select a line of text, in accordance with one embodiment of the invention.

FIG. 3 illustrates a “tap and hold” gesture to select a portion of a line of text, in accordance with one embodiment of the invention.

FIG. 4 illustrates operations is cursor mode, in accordance with one embodiment of the invention.

FIG. 4 illustrates operations in text selection mode, in accordance with one embodiment of the invention.

FIG. 6 shows a flowchart for selecting text using the gestures, in accordance with one embodiment of the invention.

FIG. 7 shows a block diagram of a system, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention disclose a technique to select text based on gestures. The technique may be implemented on any electronic device with a touch interface to support gestures. Advantageously, in one embodiment, once the text is selected, further processing is initiated based on the selected text, as will be explained.

While the category of electronic devices with a touch interface to support gestures is quite large, for illustrative purposes the invention will be described with reference to a multi-function printer/copier or scanner equipped with a touch sensitive screen. Hardware for such a device is described with reference to FIG. 5, later.

In one embodiment, a tapping gesture is used for text selection. The type of tapping gesture determines how text gets selected.

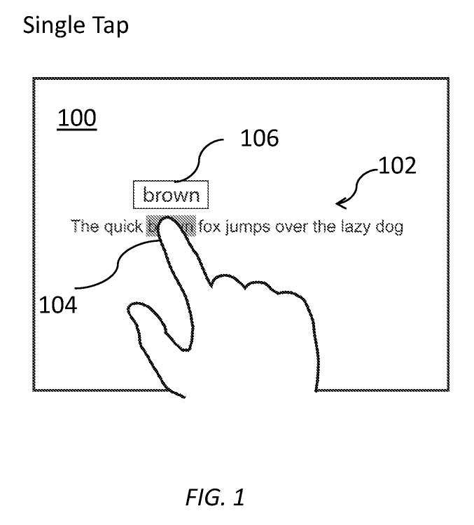

FIG. 1 of the drawings illustrates text selection with a type of tapping gesture known as a “single tap”. Referring to FIG. 1, a touch screen 100 displays the sentence 102 comprising the words “the quick brown fox jumps over the lazy dog”. Single tapping of the word brown by a finger 104 causes selection of the word “brown”, as illustrated in FIG. 1. Advantageously, the selected word is displayed in a window 106 which is laterally offset relative to the sentence 102 to enhance readability. Thus, with the “single tap” gesture, a single tap with a finger over the word desired to be selected causes selection of that word.

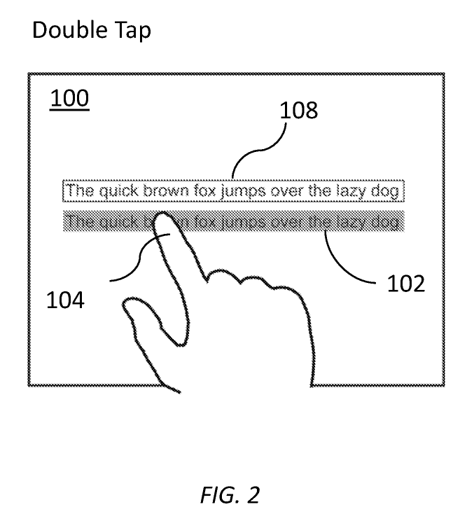

FIG. 2 of the drawings illustrates text selection using a gesture known as “double tap”. With the “double tap” gesture, a user double taps the touch screen 100 at any point where the sentence 102 is displayed. This causes the entire sentence 102 to be selected as text in the laterally offset window 108.

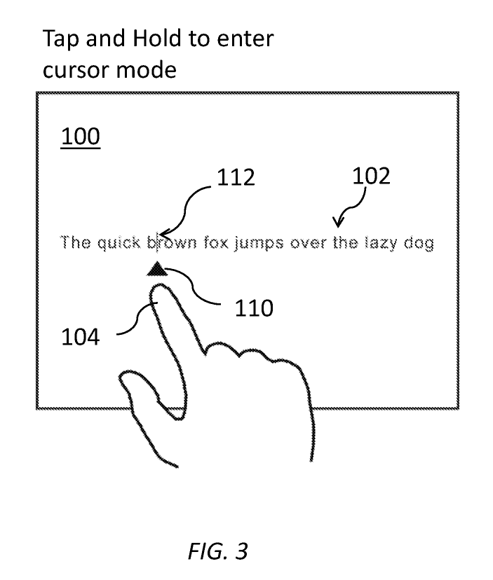

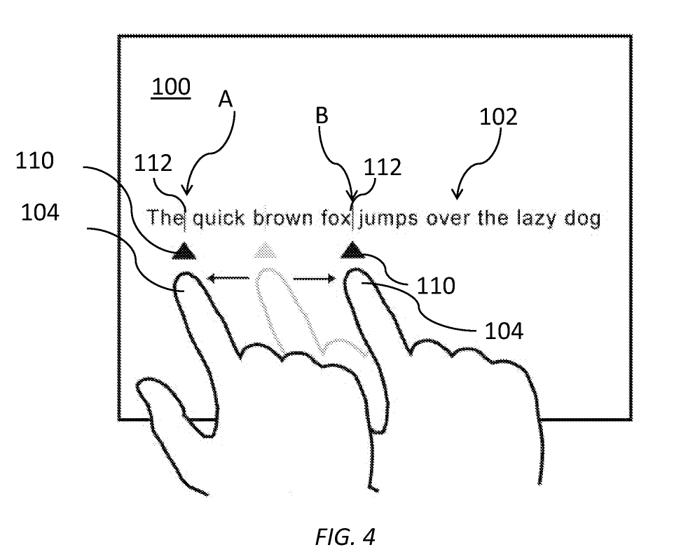

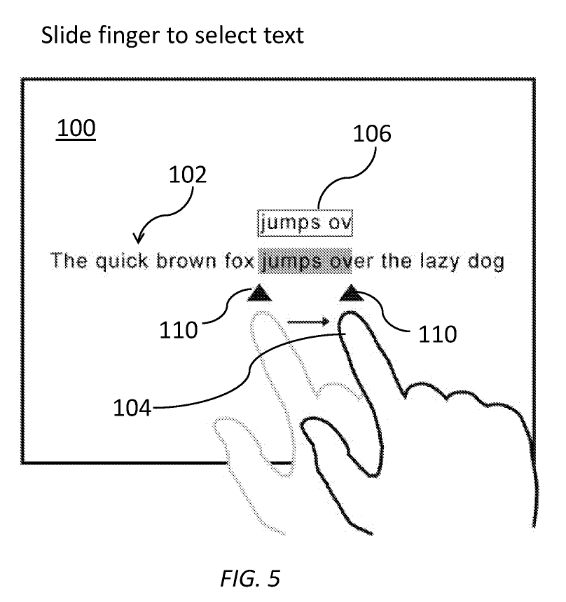

FIG. 3 of the drawings illustrates a gesture known as “tap and hold”. The “tap and hold” gesture is used to select a portion of a line of text, as will now be described. With the “tap and hold” gesture, a user touches the touch screen 100 with finger 104 adjacent or near to the first character in the sentence 102 from which text selection is to begin. Maintaining finger pressure on the touch screen 100 causes the device to transition to cursor mode. In the example shown in FIG. 3 of the drawings, the finger 104 is placed adjacent the letters “b” and “r” of the word “brown”. Maintaining finger pressure on the touch screen without releasing the finger causes a cursor control 110 to appear adjacent the word “brown”. Further, a cursor 112 is placed between the letters “b”, and “r”, as is shown. The device on now in cursor mode and the user can slide his/her finger 104 to the left or to the right a certain number of characters in order to move the position of the cursor 112 to facilitate text selection as will be described with reference to FIG. 4 of the drawings.

Referring to FIG. 4, the finger 104 is used to perform the just described tap and hold gesture on the touch screen 100 adjacent the position indicated by reference character “A”. This causes the cursor 112 to appear immediately to the right of the word “The”. If the user is happy with the position of the cursor 112 then the user releases the finger 104 as a result of which the device is placed in text selection mode. In text selection mode, the finger can be slid across the screen 100 to the left or right to cause selection of text from the current cursor position of the cursor 112 as will be explained later.

If the user in not happy with the cursor position of the cursor 112 then the user does not release the finger 104 to enter text selection mode as described above. Instead the user maintains finger pressure on the screen to cause the device to enter cursor mode. In cursor mode the user slides the finger 104 to move the cursor control 110. Movement of the cursor control 110 causes a sympathetic or corresponding movement in the position of the cursor 112. In the example of FIG. 4, the finger is slid to the right in order to move the cursor control 110 to the right. As described moving the cursor control 110 to the right causes the cursor 112 to be sympathetically moved. When the cursor has thus been moved to a desired position on the screen 100, the finger is released to enter text selection mode with the cursor in the desired position to begin text selection. In the example of FIG. 4, the desired cursor position is immediately to the right of the word “fox”.

Text selection in text selection mode is illustrated with reference to FIG. 5 of the drawings. In text selection mode, the cursor can be moved using the cursor control 110 as in cursor mode except that now text between the cursor start position and cursor end position is selected. In the example of FIG. 4, the finger is slid to the right to move the cursor 112 from its start position immediately to the right of the word “fox” to between the letters “o” and “v” of the word “over. This causes the string “jumps ov” to be placed in the window 106.

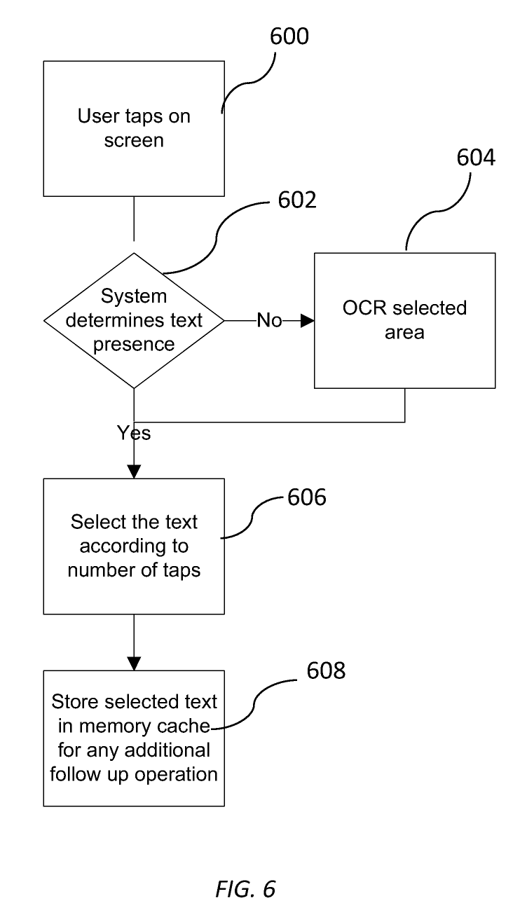

In some embodiments, the screen 100 may display an image comprising text that has not been subjected to optical character recognition (OCR). In such cases, an OCR operation is performed, as is described with reference to the flowchart of FIG. 6. Referring to FIG. 6, at block 600, a user taps on the screen 100. At block 402, the system determines that the image displayed on the screen 100 has text present, for e.g., based on its file type. For example image file types (e.g. tiff, jpg, png, etc.) do not have text information present. Further, vector-based images do not have text present. PDF format documents may or may not have text information. At the time of opening a PDF document, the system determines whether the document has text information or not, in one embodiment. If the document has text present, then processing moves to block 606. If the system determines at block 602 that the image comprises no text, then block 604 is executed. At block 604, the area which the user has attempted to select based on gestures is subject to an OCR process in order to convert it into text. After execution of the block 604, processing resumes at block 606.

At block 606, the appropriate text is selected based on the type of gesture used. Block 608 then executes, wherein the selected text is stored in memory for additional processing.

By way of example, the additional processing could include interpreting the captured texting based on its formatting. For example, text formatted as star@star.com will be interpreted as an email address, whereas text formatted as “123-456-7890” will be interpreted as a telephone number. In one embodiment, the format of the selected text may drive a subsequent related action. For example, if the system determines that the text comprises an email address, then a submenu may ask the user to send an email to this address. Another example could be if the selected text is a phone number, then the submenu may suggest to the user to either telephone, fax or send an SMS text message to this number.

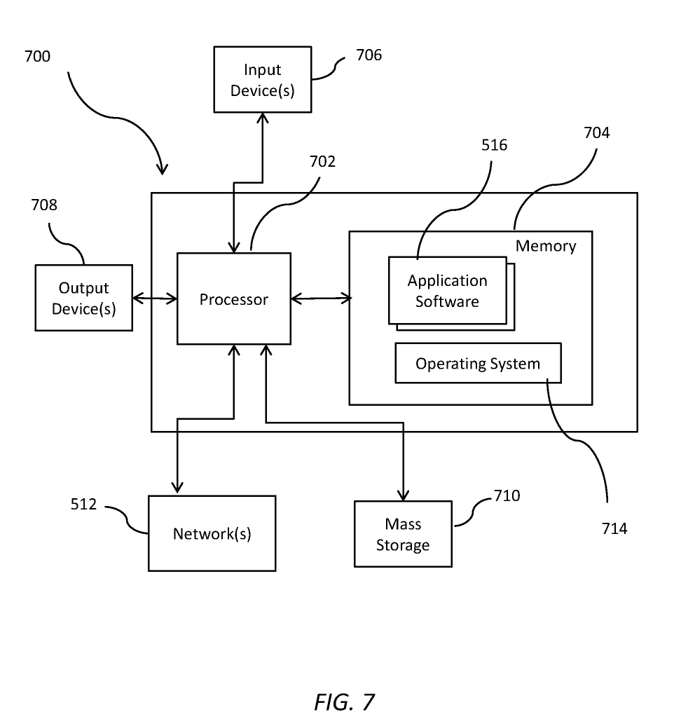

FIG. 7 of the drawings shows an example of a system 700 that is representative of a system with a touch sensitive screen to implement the above-described gesture-based text selection techniques. The system 700 may include at least one processor 702 coupled to a memory 704. The processor 702 may represent one or more processors (e.g., microprocessors), and the memory 704 may represent random access memory (RAM) devices comprising a main storage of the system 700, as well as any supplemental levels of memory e.g., cache memories, non-volatile or back-up memories (e.g. programmable or flash memories), read-only memories, etc. In addition, the memory 704 may be considered to include memory storage physically located elsewhere in the system 700, e.g. any cache memory in the processor 702 as well as any storage capacity used as a virtual memory, e.g., as stored on a mass storage device 710.

The system 700 also may receive a number of inputs and outputs for communicating information externally. For interface with a user or operator, the system 700 may include one or more user input devices 706 (e.g., a keyboard, a mouse, imaging device, touch-sensitive display screen, etc.) and one or more output devices 708 (e.g., a Liquid Crystal Display (LCD) panel, a sound playback device (speaker, etc)).

For additional storage, the system 700 may also include one or more mass storage devices 710, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 700 may include an interface with one or more networks 712 (e.g., a local area network (LAN), a wide area network (WAN), a wireless network, and/or the Internet among others) to permit the communication of information with other computers coupled to the networks. It should be appreciated that the system 700 may include suitable analog and/or digital interfaces between the processor 702 and each of the components 704, 706, 708, and 712 as is well known in the art.

The system 700 operates under the control of an operating system 714, and executes various computer software applications, components, programs, objects, modules, etc. to implement the techniques described above. Moreover, various applications, components, programs, objects, etc., collectively indicated by reference 716 in FIG. 7, may also execute on one or more processors in another computer coupled to the system 700 via a network 712, e.g. in a distributed computing environment, whereby the processing required to implement the functions of a computer program may be allocated to multiple computers over a network. The application software 716 may include a set of instructions which, when executed by the processor 702, causes the system 700 to implement the methods described above.

In general, the routines executed to implement the embodiments of the invention may be implemented as part of an operating system or a specific application, component, program, object, module or sequence of instructions referred to as “computer programs.” The computer programs may comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method for an electronic device with a touch-sensitive screen, comprising:
detecting a tapping gesture adjacent a character string displayed on the touch-sensitive screen; and
selecting characters of the character string based on the tapping gesture.

2. The method of claim 1, wherein the tapping gesture comprises a single tap, said selecting then comprising selecting a word from the character string based on a proximity of the single tap gesture to the word in the character string.

3. The method of claim 1, wherein the tapping gesture comprises a double tap, said selecting then comprising selecting the entire character string.

4. The method of claim 1, further comprising displaying the selected characters in a text box that is laterally offset from the character string.

5. The method of claim 1, wherein the tapping gesture comprises a tap and hold gesture wherein a user taps the touch-sensitive screen with a finger, whereafter the user maintains finger pressure on said screen with said finger.

6. The method of claim 5, further comprising, responsive to said tap and hold gesture, entering a cursor mode in which sliding of said finger on said screen causes sympathetic movement of a cursor.

7. The method of claim 6, further comprising entering a text selection mode upon release of said finger.

8. The method of claim 7, wherein in text selection mode sliding of the finger causes movement of the cursor from a cursor start position to a cursor end position and the characters between the cursor start position and the cursor end position to be selected.

9. The method of claim 1, further comprising performing an action based on the selected characters.

10. An electronic device, comprising:
a processor;
a memory coupled to the processor; and
a touch-sensitive screen, the memory storing instructions which when executed by the processor causes the device to perform a method comprising:
detecting a tapping gesture adjacent a character string displayed on the touch-sensitive screen; and
selecting characters of the character string based on the tapping gesture.

11. The electronic device of claim 10, wherein the tapping gesture comprises a single tap, said selecting then comprising selecting a word from the character string based on a proximity of the single tap gesture to the word in the character string.

12. The electronic device of claim 10, wherein the tapping gesture comprises a double tap, said selecting then comprising selecting the entire character string.

13. The electronic device of claim 10, further comprising displaying the selected characters in a text box that is laterally offset from the character string.

14. The electronic device of claim 10, wherein the tapping gesture comprises a tap and hold gesture wherein a user taps the touch-sensitive screen with a finger, whereafter the user maintains finger pressure on said screen with said finger.

15. The electronic device of claim 14, further comprising, responsive to said tap and hold gesture, entering a cursor mode in which sliding of said finger on said screen causes sympathetic movement of a cursor.

16. The electronic device of claim 15, further comprising entering a text selection mode upon release of said finger.

17. The electronic device of claim 16, wherein in text selection mode sliding of the finger causes movement of the cursor from a cursor start position to a cursor end position and the characters between the cursor start position and the cursor end position to be selected.

18. The electronic device of claim 10, further comprising performing an action based on the selected characters.

19. An computer-readable medium having stored thereon a sequence of instructions which when executed by a system comprising a touch-sensitive screen causes the system to perform a method, comprising:
detecting a tapping gesture adjacent a character string displayed on the touch-sensitive screen; and
selecting characters of the character string based on the tapping gesture.

20. The computer-readable medium of claim 19, wherein the tapping gesture comprises a single tap, said selecting then comprising selecting a word from the character string based on a proximity of the single tap gesture to the word in the character string.
